(19) United States
(12) Patent Application Publication
(10) Pub. No.: US 2008/0290667 A1
(43) Pub. Date: Nov. 27, 2008

(54) Latch assembly for an electronic device

(76) Inventor: Cheng-Chien Hsu, Sijhih City (TW)

Correspondence Address: Bacon & Thomas, Fourth Floor, 625 Slaters Lane, Alexandria, VA, 22314, US

(21) Appl. No.: 11/802,786

(22) Filed: May 25, 2007

(51) Int. Cl. E05C 19/02

(52) U.S. Cl. 292/70

(57) ABSTRACT

A latch assembly for an electronic device has at least one recessed latch and at least one protruding latch. Each recessed latch has two latch brackets, each having a guiding recess and a latch slot formed between the latch brackets having two catch grooves formed transversely on the latch bracket opposite to each other. Each protruding latch includes at least one resilient latch bar perpendicularly. The latch bar has a head having at least one protruding face, guided by the guiding recesses of the latch brackets and selectively engaging with the catch grooves of the respective latch slot. Accordingly, precise pre-alignment between the protruding latch and the recessed latch may not be necessary. Despite frequent use, the heads of the latch bars of the protruding latches are hardly broken or worn, so maintain a secure hold for longer than prior art.

### BACKGROUND OF THE INVENTION

1. Field of the Invention

The present invention relates to a latch assembly, and more particularly to a latch assembly for an electronic device that guides a cover relative to a case of the electronic device and holds the cover on the case stably.

2. Description of Related Art

Electronic devices such as mobile phones, PDAs and notebook computers have a case and a cover. The case and the cover both have a surface corresponding to and attaching to each other with a latch assembly mounted between the cover and the case. The latch assembly comprises multiple cavities and multiple fasteners. The cavities are respectively formed through the surface of the case. The fasteners respectively protrude from the surface of the cover corresponding to the cavities, each fastener is resilient and has a hooked tooth that extends through and engages the corresponding cavity of the cover to hold the cover securely on the case.

However, the teeth of the fasteners tend to break or wear with frequent use, reducing their ability to securely hold the case. Secondly, such an arrangement requires precise pre-alignment between the cover and the case for successful engagement. Therefore, the cover has multiple guide boards formed respectively beside the fasteners to guide the cover, increasing the cost of the manufacture of the electronic devices.

To overcome these shortcomings, the present invention provides a latch assembly for an electronic device to obviate or mitigate the aforementioned problems.

### SUMMARY OF THE INVENTION

The main objective of the present invention is to provide a latch assembly for an electronic device that guides a cover relative to a case of the electronic device to facilitate engagement and hold the cover on the case stably and firmly.

To achieve the objective, the latch assembly in accordance with the present invention comprises a recessed latch and a protruding latch.

Each recessed latch has two latch brackets and a latch slot. The latch brackets are separately formed and have inner surfaces defined opposite to each other and guiding recesses defined on the inner surfaces. The latch slot is defined between the inner surfaces of the latch brackets and has two catch grooves formed transversely on the inner surfaces of the latch bracket opposite to each other.

Each protruding latch includes at least one resilient latch bar. The latch bar is perpendicularly formed on a case of the electronic device and has a neck and a head. The head is formed on the neck of the latch bar and has a protruding face, is guided by the guiding recesses of the latch brackets and selectively engages with the catch grooves of the latch slot.

Accordingly, precise pre-alignment between the protruding latch and the recessed latch is not necessary and despite frequent use, the heads of the latch bars of the protruding latches are hardly broken or worn, so maintain a secure hold for longer than prior art.

Other objectives, advantages and novel features of the invention will become more apparent from the following detailed description when taken in conjunction with the accompanying drawings.

### BRIEF DESCRIPTION OF THE DRAWINGS

FIG. 1 is a partial exploded perspective view of a latch assembly in accordance with the present invention formed in an electronic device;

FIG. 2 is an operational exploded side view of the latch assembly in FIG. 1, disengaged;

FIG. 3 is an operational side view of the latch assembly in FIG. 1, engaged;

FIG. 4 is an operational exploded side view of a second arrangement of the latch assembly in accordance with the present invention formed in an electronic device, disengaged;

FIG. 5 is an operational side view of the latch assembly in FIG. 4, engaged;

FIG. 6 is an operational exploded side view of a third embodiment of the latch assembly in accordance with the present invention formed in an electronic device, disengaged; and

FIG. 7 is an operational side view of the latch assembly in FIG. 6, engaged.

### DETAILED DESCRIPTION OF THE PREFERRED EMBODIMENT

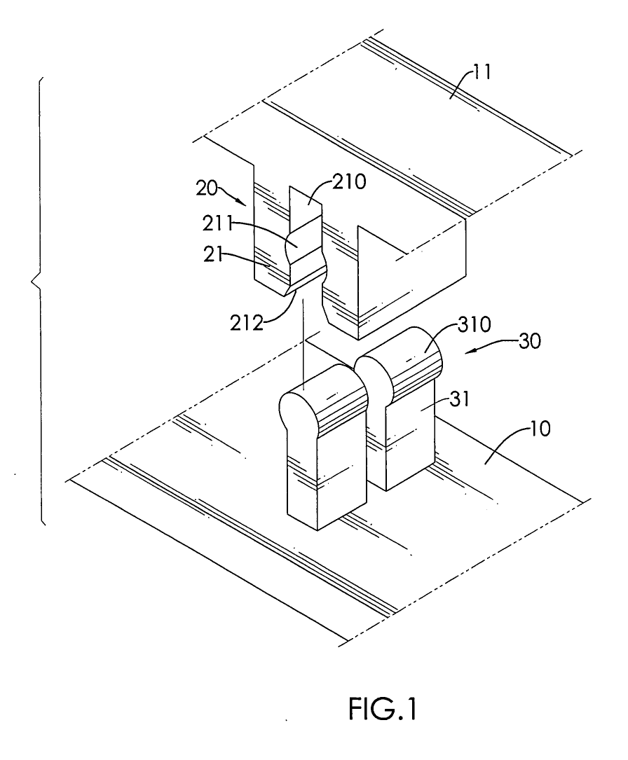

With reference to FIG. 1, an electronic device comprises a case (10) and a cover (11). The case (10) and the cover (11) both have a surface corresponding and attaching to each other using at least one latch assembly formed between the cover and the case.

Each latch assembly comprises a recessed latch (20) and a protruding latch (30).

The recessed latch (20) is a resilient material and has two latch brackets (21) and a latch slot (210). The latch brackets (21) are separately formed parallel to each other and each latch brackets (21) has an inner surface, an end and a guiding recess (212). The inner surfaces are defined opposite to each other. The guiding recess (212) is defined in the inner surface at the end of each latch bracket (21). The latch slot (210) is defined between the inner surfaces of the latch brackets (21) and has a mounting axis defined through the slot (210) and two catch grooves (211) formed transversely on the inner surfaces of each latch bracket (21) opposite to each other.

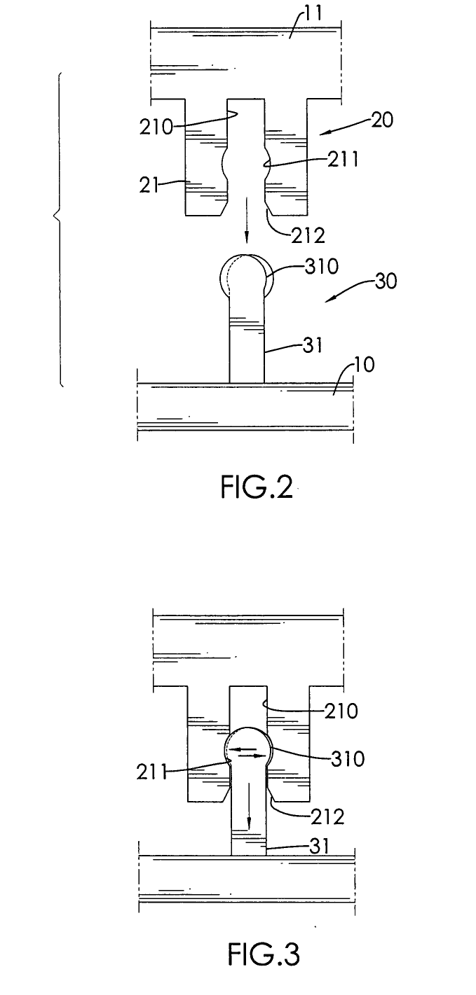

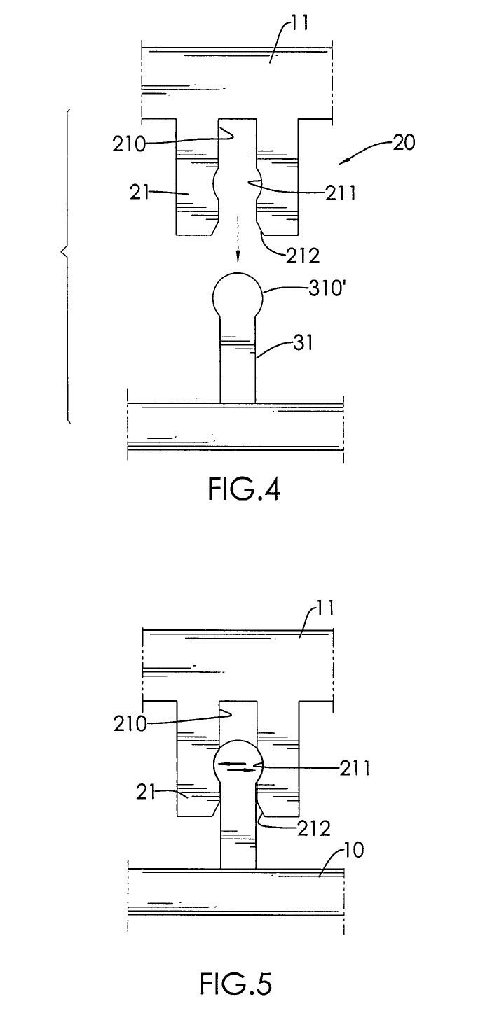

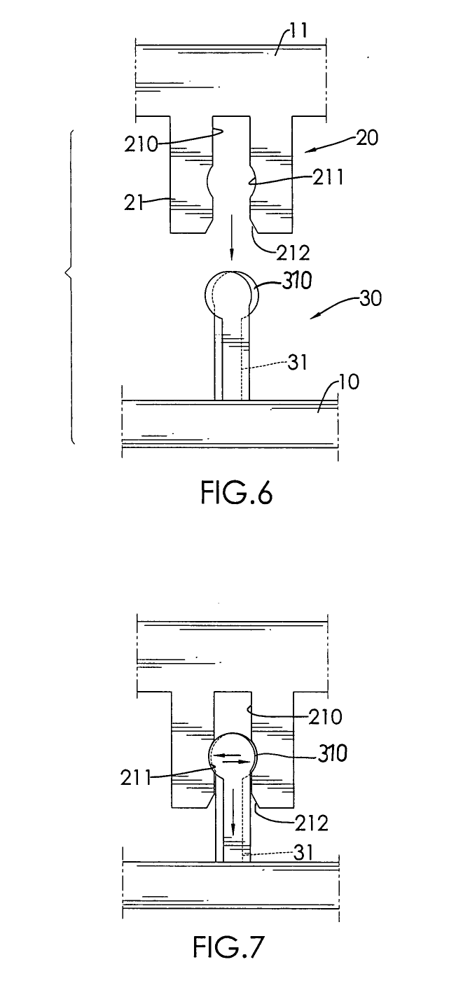

With further reference to FIGS. 2, 4 and 6, the protruding latch (30) is formed perpendicular to the case, comprises at least one resilient latch bar (31, 31′) corresponding to the latch slot (210) of the recessed latch (20).

Each latch bar (31) may be formed along the same mounting axis as the latch slot (210) of the recessed latch and has a head (310, 310′) and a neck. Each head (310, 310′) is formed on, protrudes from and is larger than the corresponding neck of the latch bar (31, 31′), has at least one protruding face and corresponds to and engages respectively with the catch grooves (211) of the latch slot (210) of the recessed latch (20).

With reference to FIGS. 3, 5 and 7, when the latch bar (31, 31′) approaches the latch slot (210), the head (310, 310′) is guided into place by the guiding recesses (212) of the brackets (21) and engage tightly with the catch grooves (211) to securely hold the cover (11) on the case (10) without requiring a second pre-aligning device, reducing the complexity and manufacturing costs of the latch.

In the first embodiment of the present invention, the head (310) of each latch bar (31) has one protruding face. The protruding faces of the latch bars (31) are formed facing each other. The latch bars (310) may be formed in line along the same mounting axis of the latch slot (210), or the latch bars (310) may be formed oppositely off the mounting axis the latch slot (210) and the protruding face formed on the neck biased to the other. Therefore, when the latch bars (31) are mounted in the latch slot (210), the neck of the latch bars (31) are slightly bent and the heads (310) can engage tightly with opposing catch grooves (211) and securely hold the cover (11) on the case (10).

In a second embodiment of the present invention, the head (310′) of each latch bar (31′) is formed wider than the latch slot (210) and have two protruding faces, may be formed as a circle in cross section. The two protruding faces of the head (310′) of each latch bar (31′) corresponding to and engaging respectively with the catch grooves (211).

When the latch bar (31′) is mounted in the latch slot (210), the latch bar (31′) forces the latch brackets (21) to widen and the catch grooves (211) securely hold the latch bar (31′) and the cover (11) is securely held by the case (10).

Despite frequent use, the head (310, 310′) of the latch bar (31, 31′) of the protruding latches (30) are hardly broken or worn, and will hold cover (11) to the case (10) together for longer than prior art.

Even though numerous characteristics and advantages of the present invention have been set forth in the foregoing description together with details of the structure and function of the invention, the disclosure is illustrative only. Changes may be made in detail especially in matters of shape, size and arrangement of parts within the principles of the invention to the full extent indicated by the broad general meaning of the terms in which the appended claims are expressed.

What is claimed is:

1. A latch assembly for an electronic device having a case and a cover comprising
a recessed latch being a resilient material and having
two latch brackets being separately formed and each latch bracket having
an inner surface defined opposite to the inner surface of the other latch bracket;
an end; and
a guiding recess defined in the inner surface at the end of the latch bracket; and
a latch slot being defined between the inner surfaces of the latch brackets and having
a mounting axis defined through the slot; and
two catch grooves formed transversely in the inner surfaces of each latch bracket opposite to each other; and
a protruding latch comprising at least one resilient latch bar corresponding to the latch slot of the recessed latch and each one of the at least one resilient latch bar having
a neck; and
a head being formed on, protruding from and being larger than the neck of the latch bar, having at least one protruding face and corresponding to and engaging respectively with at least one of the catch grooves of the latch slot of the recessed latch.

2. The latch assembly as claimed in claim 1, wherein the protruding latch comprises two latch bars, and each latch bar has a protruding face being formed opposite to the protruding face of the other latch bar.

3. The latch assembly as claimed in claim 1, wherein the protruding latch comprises two latch bars, the head of each latch bar is wider than the latch slot and each latch bar has two protruding faces corresponding to and engaging respectively with the catch grooves of the latch slot.

4. The latch assembly as claimed in claim 2, wherein the latch bars are mounted along the corresponding mounting axis of the latch slot.

5. The latch assembly as claimed in claim 2, wherein the latch bars are relatively mounted oppositely off center to the mounting axis of the latch slot; and
the protruding face of each latch bar being formed on the neck biased to the protruding face of the other latch bar.

6. The latch assembly as claimed in claim 3, wherein the head of each latch bar is formed as a circle in cross section.
